(19) United States
(12) Patent Application Publication
(10) Pub. No.: US 2019/0241796 A1
(43) Pub. Date: Aug. 8, 2019

(54) POLYMERIC DRAG REDUCING COMPOSITIONS AND METHODS FOR REDUCING DRAG AND/OR INCREASING VISCOSITY OF FLUIDS IN OIL AND/OR GAS WELLS

(71) Applicant: Flotek Chemistry, LLC, Houston, TX (US)

(72) Inventors: Nicole Mast, Spring, TX (US); Philip Sullivan, Bellaire, TX (US); Andrei Zelenev, Spring, TX (US); Nina Regmi, Houston, TX (US)

(73) Assignee: Flotek Chemistry, LLC, Houston, TX (US)

(21) Appl. No.: 16/271,136

(22) Filed: Feb. 8, 2019

Related U.S. Application Data
(60) Provisional application No. 62/628,224, filed on Feb. 8, 2018.

(51) Int. Cl. C09K 8/68; C09K 8/72; C09K 8/74; E21B 43/267

(52) U.S. Cl. CPC C09K 8/68; C09K 8/725; C09K 2208/28; E21B 43/267; C09K 8/74

(57) ABSTRACT

Polymeric drag reducing compositions comprising polymers for treatment in various aspects of a life cycle of an oil and/or gas well, and related methods, are provided. In some embodiments, the drag reducing composition comprises a fast-dissolving polymer and a slow-dissolving polymer slurry. In some embodiments, the fast-dissolving polymer comprises a cationic and/or anionic polyacrylamide, and the slow-dissolving polymer slurry comprises guar, clay, and oil. In some embodiments, compositions can be used in methods for treating an oil and/or gas well, having a wellbore. The drag reducing composition may be injected into the wellbore to reduce drag in the wellbore and/or increase viscosity of the carrier fluid.

### RELATED APPLICATIONS

This application claims priority to U.S. Provisional Patent Application Ser. No. 62/628,224, filed on Feb. 8, 2018, which is incorporated herein by reference in its entirety.

### FIELD OF INVENTION

Polymeric drag reducing compositions comprising polymers for use in various aspects of a life cycle of an oil and/or gas well, and related methods, are provided.

### BACKGROUND

Well-treatment fluid (sometimes referred to as treatment fluid or fluid) compositions are commonly employed in a variety of operations related to the extraction of hydrocarbons, such as well stimulation and coiled tubing operations. Subterranean formations are often stimulated to improve recovery of hydrocarbons. Common stimulation techniques include hydraulic fracturing and acidizing. Hydraulic fracturing consists of the high pressure injection of a fluid (e.g., a carrier fluid such as water or brine) containing suspended proppant into the wellbore in order to create fractures in the rock formation and facilitate production of hydrocarbons from hydrocarbon-containing zones, including those with low permeability. Acidizing consists of the high pressure injection of acids (e.g. hydrochloric acid) into the wellbore to dissolve limestone, dolomite, mud deposits, and other sediments that inhibit the permeability of the rock formation, while also creating fractures in the rock formation to facilitate production of hydrocarbons.

In hydraulic fracturing and acidizing, proppants (e.g., silica sand) act as a physical barrier to the closure of fractures, and thus, need to be sufficiently strong to withstand high closure stresses and pressures found in rock formations. Delivery of proppants to the fractures has been a known technological challenge as the proppants need to be suspended without premature settling in the carrier fluid. Various methods of delivering proppants exist, such as increasing the flow rate of the carrier fluid, increasing the viscosity of the carrier fluid, and/or changing the material properties of the proppant. The choice of a specific treatment fluid and pumping conditions would be typically known to a person skilled in the art.

Treatment fluids may comprise viscosifying polymers known to thicken the carrier fluids and upon hydration and dissolution yield thick linear gel capable of transporting the proppant. Such viscosified fluids may contain an additional crosslinking agent which upon interaction with a polymer, yields a crosslinked gel, allows one to increase viscosity to even higher levels as compared to those achieved with using a linear gel.

The treatment fluid injected into the well may comprise a brine and a drag reducing composition. The treatment fluid may be generated when the brine and the drag reducing composition are added on the fly or mixed at pump inlet of the well. Brine refers to aqueous solutions comprising various salts (e.g., sodium chloride, calcium chloride, potassium chloride) and salt mixtures. Brines may be used in various well treatment operations, such as completions and workover. Water produced from the well may also comprise brine. The treatment fluid comprising a drag reducing composition may provide an increased viscosity needed to transport the proppant at least to some degree.

In choosing a proper treatment fluid, cost considerations often play a determining role. Lower cost treatment fluids with viscosities much lower than the viscosity of linear gels or crosslinked gels pumped at rates high enough to prevent proppant settling can also be used to deliver proppants. Fracturing process utilizing such treatment fluids is referred to as slickwater fracturing. Slickwater fracturing fluids typically comprise water, brine, and/or a polymer. While the polymer is expected to increase viscosity of the fluid to which it is added at least to some extent, its main function and purpose is to provide drag reduction to ensure effective pumping at high rates. Under the conditions when the viscosity of fluid is not high enough to stipulate effective transport of proppant, the latter is achieved by higher pumping rates.

In the process of proppant delivery by pumping a proppant-containing fluid at a high rate, a substantial drag-induced pressure loss is observed between the treatment fluid and piping, tubing, or casing once the fluid reaches turbulent flow. Pressure loss due to fluid drag results in a substantial energy loss, which in turn results in the need to perform fracturing operation at a higher pumping pressure and to utilize additional pumping equipment. To address this issue, it is a common practice to include drag reducing additives in the hydraulic fracturing or acidizing fluid. The common feature of drag reducing additives is the ability to provide maximum and sustainable levels of drag reduction within the time scale relevant to the pumping process. Achieving high levels of drag reduction in a variety of brines with varying levels of salinity and maximizing the rate at which the highest possible level of drag reduction can be reached during pumping are known challenges in the industry.

During pumping under high shear conditions, drag reduction performance of synthetic and natural drag reducers is known to decline. Such a decline in drag reduction leads to the loss of effectiveness of the drag reducer. The effectiveness of a drag reducing composition is also impacted by the chemical environment of the fluid. Presence of high amounts of dissolved salts interfere with the ability of the polymer to efficiently and effectively reduce drag. A number of brine-tolerant drag reducing compositions are known in the art. Some examples of such brine-tolerant drag reducing compositions include polymers, which are known to be produced by co-polymerizing 2-acrylamido-2-methylpropane sulphonic acid (AMPS) and its salts with other monomers. Non-limiting examples of brine-tolerant drag reducing polymers are described in U.S. Patent Publication No. 20160017203A1 incorporated herein as a reference in its entirety.

The preservation of a high level of drag reduction, or increasing the extent of drag reduction without a substantial increase in the amount of added polymer remains a challenge. In addition to contributing to an increase in the cost, the increase in the dose of drag reducer leads to polymer deposition on the face of the rock and causes formation damage. One thus is facing the challenge of maintaining a balance between reducing drag in high-speed pumping, increasing viscosity for effective and efficient proppant transfer and placement, minimizing formation damage and controlling the costs. Therefore, there is a need for the development of improved compositions or additives for use in hydraulic fracturing fluids or acidizing fluids that would exhibit satisfactory proppant-carrying capabilities while maintaining efficient pumping rates at an optimum cost. There is also a need for improved fracturing fluid or acidizing fluid additives and improved efficiency of fracturing fluids or acidizing fluids for proppant delivery.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 is, according to certain embodiments, a plot of drag reduction as a function of time for a variety of compositions set forth in the legend;

FIG. 2 is, according to certain embodiments, a plot of viscosity as a function of shear rate for a variety of compositions set forth in the legend; and

FIG. 3 is, according to certain embodiments, a plot of viscosity as a function of wt % of fast-dissolving polymer added to slow-dissolving polymer slurry.

FIG. 4 is, according to certain embodiments, a plot of viscosity of Example 5 compositions in different TDS brines at a shear rate of 2 s⁻¹.

FIG. 5 is, according to certain embodiments, a plot of viscosity of Example 5 compositions in different TDS brines at a shear rate of 40 s⁻¹.

FIG. 6 is, according to certain embodiments, a plot of drag reduction effectiveness in fresh water of Example 5 compositions comprising cationic fast-dissolving polymers. The Example 5 composition was dosed at 0.5 gpt.

FIG. 7 is, according to certain embodiments, a plot of drag reduction effectiveness in a brine comprising 150,000 ppm of TDS and 100 ppm of Fe (iron) of Example 5 compositions comprising cationic fast-dissolving polymers. The Example 5 composition was dosed at 0.5 gpt.

### SUMMARY

Generally, compositions comprising polymers for use in various aspects of a life cycle of an oil and/or gas well, and related methods, are provided. According to some embodiments, a drag reducing composition (also may be referred to as a drag reducing additive, drag reducer, friction reducing composition, friction reducing additive, or friction reducer) for treating an oil and/or gas well having a wellbore in a subterranean formation is described, wherein the drag reducing composition comprises a fast-dissolving polymer and a slow-dissolving polymer slurry, wherein the slow-dissolving polymer slurry comprises a slow-dissolving polymer. In certain embodiments, the fast-dissolving polymer is a polymer that when dosed at two pounds per thousand gallons of the carrier fluid, reaches maximum drag reduction at a time less than or equal to two minutes. In some embodiments, the slow-dissolving polymer slurry is a slurry that when dosed at two pounds per thousand gallons of the carrier fluid, reaches maximum drag reduction at a time greater than two minutes.

In one aspect, a method of treating a well in a subterranean formation using a treatment fluid is provided. The method comprises providing a drag reducing composition comprising a slow-dissolving polymer slurry and a fast-dissolving polymer. The fast-dissolving polymer is present in an amount of less than or equal to 10 wt % versus the total drag reducing composition. The method further comprises providing a brine having a total dissolved solids of greater than or equal to 100,000 ppm and combining the drag reducing composition and the brine together to form the treatment fluid. The method further comprises injecting the treatment fluid into the well.

In one aspect, a method of treating a well in a subterranean formation using a treatment fluid is provided. The method comprises providing a drag reducing composition comprising a slow-dissolving polymer slurry and a fast-dissolving polymer. The fast-dissolving polymer is present in an amount of greater than 10 wt % versus the total drag reducing composition. The method further comprises providing a brine having a total dissolved solids of less than 100,000 ppm and combining the drag reducing composition and the brine together to form the treatment fluid. The method further comprises injecting the treatment fluid into the well.

Some embodiments described herein are related to a method of treating an oil and/or gas well having a wellbore, wherein the wellbore comprises one or more carrier fluids, comprising delivering a composition into the wellbore, wherein the composition comprises a fast-dissolving polymer and a slow-dissolving polymer slurry, and causing the composition to travel through the one or more carrier fluids to reduce drag in the wellbore and/or increase viscosity of the one or more carrier fluids.

For the compositions and methods described above, in certain embodiments, the composition comprises from about 2 wt % to about 30 wt % of a fast-dissolving polymer versus the total weight of the composition, and from about 70 wt % to about 98 wt % of a slow-dissolving polymer slurry versus the total weight of the composition.

For the compositions and methods described above, in certain embodiments, the fast-dissolving polymer is a cationic copolymer of polyacrylamide.

For the compositions and methods described above, in certain embodiments, fast-dissolving polymer is an anionic copolymer of polyacrylamide.

For the compositions and methods described above, in certain embodiments, the fast-dissolving polymer is a nonionic copolymer of polyacrylamide.

For the compositions and methods described above, in certain embodiments, the fast-dissolving polymer is a zwitterionic copolymer of polyacrylamide.

For the compositions and methods described above, in certain embodiments, the slow-dissolving polymer slurry comprises guar, clay, and oil.

For the compositions and methods described above, in certain embodiments, the composition is added to a carrier fluid.

For the compositions and methods described above, in certain embodiments, the composition is added to the carrier fluid at a concentration of about 0.25 gallons of composition per thousand gallons of carrier fluid.

For the compositions and methods described above, in certain embodiments, the composition is added to the carrier fluid at a concentration of about 1 gallon of composition per thousand gallons of carrier fluid.

For the compositions and methods described above, in certain embodiments, the composition is added to the carrier fluid at a concentration of about 6 gallons of composition per thousand gallons of carrier fluid.

For the compositions and methods described above, in certain embodiments, the composition is added to the carrier fluid at a concentration of about 10 gallons of composition per thousand gallons of carrier fluid.

For the compositions and methods described above, in certain embodiments, the carrier fluid is a hydraulic fracturing fluid.

For the compositions and methods described above, in certain embodiments, the carrier fluid is an acidizing fluid. For the compositions and methods described above, in certain embodiments, the carrier fluid comprises a proppant.

For the compositions and methods described above, in certain embodiments, the carrier fluid comprises total dissolved solids.

For the compositions and methods described above, in certain embodiments, the carrier fluid comprises between about 50,000 total dissolved solids and about 350,000 total dissolved solids.

Other aspects, embodiments, and features of the methods and compositions will become apparent from the following detailed description. All patent applications and patents incorporated herein by reference are incorporated by reference in their entirety. In case of conflict, the present specification, including definitions, will control.

### DETAILED DESCRIPTION

Compositions comprising polymers for use in various aspects of a life cycle of an oil and/or gas well, and related methods, are provided. In some embodiments, the drag reducing composition comprises a fast-dissolving polymer and a slow-dissolving polymer slurry. In some embodiments, the fast-dissolving polymer comprises an acrylamide-based polymer and the slow-dissolving polymer comprises a polysaccharide. In some embodiments, the slow-dissolving polymer is provided as a slurry comprising other components, for example, oil, clay, and/or water-immiscible liquids, such as hydrocarbon liquids. In some embodiments, compositions can be used in methods for treating an oil and/or gas well having a wellbore. A composition may be added to a carrier fluid and delivered into the wellbore, thereby reducing drag in the wellbore and/or increasing the viscosity of the carrier fluid depending on the application and the effect desired. In some embodiments, the carrier fluid is an aqueous carrier fluid.

In certain embodiments, the fast-dissolving polymer and the slow-dissolving polymer slurry work synergistically to reduce drag in the wellbore and/or increase the viscosity of the carrier fluid. In oil and/or gas production, the wellbore is typically filled with carrier fluids, either water, brine, oil, or a combination of these fluids.

In certain embodiments, the slurry containing fast-dissolving and slow-dissolving polymer allow one to simultaneously achieve benefits of achieving viscosity sufficient to carry proppant and the extent of drag reduction necessary to achieve the maximum pumping capacity with the equipment available at the well site. In well stimulation operations, the wellbore may need to be treated with a drag reducing composition to reduce drag between the carrier fluid and the inner walls of pipes and tubing leading up to and connected to the wellhead (e.g. located above the surface) that experience turbulent flow. In some cases, the wellbore may need to be treated with a drag reducing composition to reduce drag between the carrier fluid and the inner walls of casing (e.g. located downhole) that experience turbulent flow. In turbulent flow, the dissipation of energy takes place on the eddies of turbulence. The added drag reducer polymers interact with eddies, lower energy losses, and thus, allow for efficient use of available pumping equipment. According to some embodiments, the drag reducing composition may be referred to as a friction reducing composition, or simply a friction reducer. In some embodiments, the drag reducing composition may reduce drag between the carrier fluid and the pipes or tubing leading up and/or connected to the wellhead (e.g., above ground). In certain embodiments, the drag reducing composition may reduce drag between the carrier fluid and the inner walls of casing (e.g. downhole).

In some embodiments, proppants (e.g., silica sand, coated silica sand, or ceramic proppant) can be added to carrier fluids for wellbore treatment (including horizontal, vertical, and deviated wellbores). The placement of proppants into the fractures generated in the formation in the course of a stimulation operation prevents these fractures from closing and ensures more effective transport of hydrocarbons towards the wellbore. Properties of the carrier fluid and the proppant, as well as pumping conditions and hydraulic fracturing operational strategies, are essential for the successful placement of proppant into the fractures. In certain cases, low-viscosity fluids are not ideal for delivering proppants, as proppant grains may fall out of the fluid prior to being delivered and placed into fractures, causing undesirable formation of deposits, such as sand dunes, and poor effective fracture length and poor conductivity. Furthermore, polymers dissolved in low-viscosity fluids may become deposited in the fractures or on the face of formation causing formation damage. This puts additional restrictions on the loading or dose or concentrations of drag reducing polymers that can be used in the well-treatment fluids.

Alternatively, high-viscosity fluids are more effective in keeping proppant suspended than low viscosity fluids, and proppant can be placed into fractures more effectively when the viscosity of the fluid has been increased. Achieving both maximum drag reduction effectiveness and maximum viscosity for proppant transport typically cannot be achieved instantly, and specialized polymer hydration equipment is often required at the well site. In some applications, low viscosity fluids with low proppant loading are used to initiate multiple fractures at the beginning of a fracturing stage. Later in the stage, higher viscosity fluids are needed to carry the higher proppant loadings and propagate the fractures. This typically requires a change in the polymer component of the fluid and the addition of hydration equipment and/or the addition of additional chemicals used to properly prepare the polymers used to generate the needed viscosity to suspend higher proppant loadings. In certain embodiments, both of these operations (e.g. drag reduction and/or increased viscosity) are achieved with a single additive by altering the dosage or loading or concentration depending on the desired effect without the need for additional equipment or chemicals to be present at the well site.

Without wishing to be bound by theory, the compositions described herein may advantageously reduce drag in the wellbore and/or increase the viscosity of the carrier fluid, in part, depending on the amount (e.g. the concentration or dosages or loading) of the composition provided to the wellbore. The ability to alter the ratio of fast-dissolving polymers and slow-dissolving polymer slurries allows one skilled in the art to balance off and minimize negative effects associated with the use of high and low viscosity fluids. For example, at lower doses of the composition (e.g., between about 0.25 and about 1 gallon per thousand gallons of carrier fluid), a reduction in drag may be observed, however, the viscosity of the carrier fluid may not increase. As another example, at higher doses of the composition (e.g., between about 1 and about 10 gallon per thousand gallons of carrier fluid), a reduction in drag and an increase in the viscosity of the carrier fluid may be observed. Accordingly, the amount of the composition provided to the wellbore may be tuned depending on the desired outcome. In certain embodiments, the single composition comprising a fast-dissolving polymer and a slow-dissolving polymer slurry serves as a dual-purpose composition (e.g., to reduce drag and increase viscosity).

In some embodiments, the drag reducing composition comprises a fast-dissolving polymer and a slow-dissolving polymer slurry. In some embodiments, the drag reducing composition comprises at least about 1 wt %, or at least about 2 wt %, or at least about 3 wt %, or at least about 4 wt %, or at least about 5 wt %, or at least about 10 wt %, or at least about 15 wt %, or at least about 20 wt %, or at least about 25 wt %, or at least about 30 wt %, or at least about 35 wt %, or at least about 40 wt %, or more, of the fast-dissolving polymer, versus the total weight of the drag reducing composition.

In some embodiments, the drag reducing composition comprises less than or equal to about 1 wt %, or less than or equal to about 2 wt %, or less than or equal to about 3 wt %, or less than or equal to about 4 wt %, or less than or equal to about 5 wt %, or less than or equal to about 7 wt %, or less than or equal to about 10 wt %, or less than or equal to about 15 wt %, or less than or equal to about 20 wt %, or less than or equal to about 25 wt %, or less than or equal to about 30 wt %, or less than or equal to about 35 wt %, or less than or equal to about 40 wt %, or more, of the fast-dissolving polymer, versus the total weight of the drag reducing composition.

In some embodiments, the drag reducing composition comprises greater than or equal to about 1 wt %, or greater than or equal to about 2 wt %, or greater than or equal to about 3 wt %, or greater than or equal to about 4 wt %, or greater than or equal to about 5 wt %, or greater than or equal to about 7 wt %, or greater than or equal to about 10 wt %, or greater than or equal to about 15 wt %, or greater than or equal to about 20 wt %, or greater than or equal to about 25 wt %, or greater than or equal to about 30 wt %, or greater than or equal to about 35 wt %, or less greater or equal to about 40 wt %, or more, of the fast-dissolving polymer, versus the total weight of the drag reducing composition.

The slow-dissolving polymer can be present in a slurry at any concentration that provides for a flowable and/or pumpable slurry that can be effectively mixed with the fast-dissolving polymer to make well-treatment composition. In some non-limiting embodiments, the concentration of slow-dissolving polymer in the slurry is less than about 60% by weight, less than about 50% by weight, less than about 40% by weight, and less than about 30% by weight, versus the total slow-dissolving polymer slurry composition.

In embodiments wherein the composition comprises a fast-dissolving polymer and a slow-dissolving polymer slurry, the composition may comprises X wt % of the fast-dissolving polymer, and 100-X wt % of a slow-dissolving polymer slurry. Combinations of the above-referenced ranges are also possible (e.g., greater than or equal to 1 wt % and less than or equal to 40 wt %). In some embodiments, the composition may comprise from about 2 wt % to 30 wt % of the fast-dissolving polymer, and about 70 wt % to 98 wt % of the slow-dissolving polymer slurry, versus the total weight of the composition. In some embodiments, the drag reducing composition may comprise from about 0.5 wt % to about 10 wt % of the fast-dissolving polymer, and about 90 wt % to 99.5 wt % of the slow-dissolving polymer slurry, versus the total weight of the drag reducing composition. In some embodiments, the drag reducing composition may comprise from about 0.1 wt % to about 10 wt % of the fast-dissolving polymer, and about 90 wt % to 99.9 wt % of the slow-dissolving polymer slurry, versus the total weight of the drag reducing composition. In some embodiments, the composition includes about 2 wt % of the fast-dissolving polymer versus the total weight of the composition, and about 98 wt % of the slow-dissolving polymer slurry versus the total weight of the composition. In certain embodiments, the composition includes about 30 wt % of the fast-dissolving polymer versus the total weight of the composition, and about 70 wt % of the slow-dissolving polymer slurry, versus the total weight of the composition.

In certain embodiments, the drag reducing composition comprises a fast-dissolving polymer. According to certain embodiments, a fast-dissolving polymer can generally be understood as a polymer that when dosed at two pounds per thousand gallons of carrier fluid (e.g., aqueous solution), reaches maximum drag reduction at a time less than or equal to two minutes on a flow loop test (e.g., see working examples). In some embodiments, the drag reducing composition comprises from about 2 wt % to about 30 wt %, or from about 5 wt % to 25 wt %, or from about 10 wt % to 20 wt %, or from about 12 wt % to about 18 wt %, or from about 14 wt % to about 16 wt % of the fast-dissolving polymer, versus the total weight of the drag reducing composition.

In certain embodiments, when the drag reducing composition comprising the fast-dissolving polymer is added to the carrier fluid of a wellbore, the fast-dissolving polymer aids in reducing drag between the carrier fluid and the inner side walls of the pipes or tubes connected to the wellhead and/or the inner side walls of the casing found downhole in the wellbore. In certain embodiments, the fast-dissolving polymer provides a reduction in drag at short time scale (e.g. 1 minute). According to some embodiments, the fast-dissolving polymer provides a reduction in drag at a time scale of greater than about 0.10 minutes, greater than about 0.20 minutes, greater than about 0.50 minutes, greater than about 1.0 minute, greater than about 1.5 minutes, or greater than about 1.9 minutes. In certain embodiments, the fast-dissolving polymer provides a reduction in drag at a time scale of less than about 2.0 minutes, less than about 1.5 minutes, less than about 1.0 minute, less than about 0.50 minutes, less than about 0.20 minutes, or less than about 0.10 minutes. Combinations of these ranges are also possible (e.g., greater than 1.0 minute and less than 2.0 minutes, greater than 0.10 minutes and less than 0.50 minutes).

According to certain embodiments, the fast-dissolving polymer may be a synthetic or non-synthetic polymer. In some embodiments, the fast-dissolving polymer is an acrylamide-based polymer or co-polymer. In some embodiments, the fast-dissolving polymer comprises a synthetic polymer. In some embodiments, the synthetic polymer comprises polyacrylamide. The acrylamide-based polymer or co-polymer may be nonionic, zwitterionic, amphoteric, cationic, or anionic. As will be known to those of ordinary skill in the art, acrylamide-based polymers or co-polymers are derived from polymerized acrylamide subunits or such subunits co-polymerized with other monomers. To a person of ordinary skill in the art, such acrylamide-based polymers or co-polymers are also known as nonionic, zwitterionic, amphoteric, cationic, or anionic polyacrylamides.

In some embodiments, the polymer may be a dispersion polymer or an emulsion polymer, which may be nonionic, zwitterionic, amphoteric, anionic, or cationic. Such dispersion polymer preferably consists of acrylamide present in the amount between 1 and 100 mole % and cationic, anionic, zwitterionic, amphoteric, or nonionic monomers present in the amount between 0 and 99 mole %. When the copolymer includes acrylamide and an anionic monomer, the anionic monomer may be acrylamidopropanesulfonic acid, acrylic acid, methacrylic acid, monoacryloxyethyl phosphate, or their alkali metal salts. When the copolymer includes acrylamide and a cationic monomer, the cationic monomer may be dimethylaminoethylacrylate methyl chloride quaternary salt, diallyldimethylammonium chloride (DADMAC), (3-acrylamidopropyl)trimethylammonium chloride (MAPTAC), (3-methacrylamido)propyltrimethylammonium chloride, dimethylaminoethyl-methacrylate methyl chloride quaternary salt, or dimethylaminoethylacrylate benzylchloride quaternary salt. When the copolymer includes acrylamide and a nonionic monomer, the nonionic monomer may be acrylamide, methacrylamide, N-methylacrylamide, N,N-dimethyl(meth)acrylamide, octyl acrylamide, N(2-hydroxypropyl)methacrylamide, N-methylolacrylamide, N-vinylformamide, N-vinylacetamide, N-vinyl-N-methylacetamide, poly(ethylene glycol)(meth)acrylate, poly(ethylene glycol) monomethyl ether mono(meth)acrylate, N-vinyl-2-pyrrolidone, glycerol mono((meth)acrylate, 2-hydroxyethyl (meth)acrylate, vinyl methylsulfone, or vinyl acetate. When the copolymer includes acrylamide and a zwitterionic monomer, the zwitterionic monomer may be selected from those described in U.S. Pat. No. 6,709,551 or be selected from N,N-dimethyl-N-acryloyloxyethynyl-N-(3-sulfopropyl)-ammonium betaine, N,N-dimethyl-N-acrylamidopropyl-N-(2-carboxymethyl)-ammonium betaine, N,N-dimethyl-N-methacrylcryloyloxyethynyl-N-(3-sulfopropyl)-ammonium betaine, N,N-dimethyl-N-methacrylcryloyloxyethynyl-N-(3-sulfopropyl)-sulfonium betaine, 2-(methylthio)ethyl methacryloyl-S-(sulfopropyl)-sulfonium betaine, 2-[(2-acryloylethyl)dimethylammonio]ethyl 2-methyl phosphate, 2-(acryloyloxyethyl)-2′-(trimethylammonium)ethyl phosphate, or [(2-acryloylethyl)dimethylammonio]methyl phosphonic acid. It will be understood that the lists of potential monomers are not limiting, and the use of other monomers may also be appropriate.

Other non-limiting examples of fast-dissolving polymers include partially hydrolyzed polyacrylamide, polyvinyl alcohol, polyethylene glycol, and the like.

In some embodiments, the fast-dissolving polymer of the drag reducing composition is in the form of a commercially-available polymer emulsion, which typically already includes some solvent and at least one surfactant. Polymer emulsion could be synthesized, instead of purchased. It will be understood that the term “polymer” includes both homopolymers and copolymers. In the embodiment where the fast-dissolving polymer is a polymer emulsion, it is understood that the term “fast-dissolving” may also mean that the emulsion is a fast-inverting polymer emulsion. The concept of polymer emulsion inversion would be known to those skilled in the art.

In some embodiments, the fast-dissolving polymers that are suitable to practice the present invention may also be chosen from a class of dispersion polymers, such as those described in U.S. Pat. Nos. 4,929,655; 5,605,970; 5,837,776; 5,597,858; 6,217,778; 6,365,052; 7,323,510; and European patent EP 630,909, each of which is incorporated herein by reference in its entirety and for all purposes. Use of dispersion polymers for reducing drag has been disclosed in U.S. Pat. No. 6,787,506, which is incorporated herein by reference in its entirety and for all purposes. Dispersion polymers may either be acquired from a commercial source or synthesized. Typical synthesis of dispersion polymers involves polymerizing one or more water-soluble monomers in an aqueous reaction mixture, wherein the aqueous reaction mixture contains a water soluble salt, at least one polymeric dispersant, optionally contains an organic alcohol, optionally contains a pre-formed polymer seed. The water soluble polymer formed as a result of polymerization is insoluble in the aqueous reaction mixture at the concentration thereof formed during the polymerization. Polymer solids in the prepared dispersion are typically from about 5% to about 60% by weight.

Dispersion polymers were developed in an effort to bring to market more environmentally-friendly polymer formulations. The dispersion polymer is typically limited to the selected polymer and an aqueous saline solution. The dispersion polymer technology is very different from emulsion polymer technology because there is no water-insoluble oil or emulsifying or inverting surfactants involved in making dispersion polymers. Therefore, the term “inversion” commonly associated with emulsion polymers does not have any technical meaning in relationship to dispersion polymers. The polymer coil of a dispersion polymer is released from its compact state in which it is present in the saline solution upon dilution with water while applying shear stress, such as for example, in mixing. In making a composition utilizing a fast-dissolving dispersion polymer, one would need to overcome an issue of possible incompatibility between the fast-dissolving dispersion polymer and the slow-dissolving polymer slurry. In one embodiment suitable, the drag reducing composition can be made by combining a fast-dissolving dispersion polymer with a slurry of slow-dissolving polymer slurry in a solvent that is miscible or compatible with dispersion polymers. Compositions of such embodiments are either fully aqueous or at least to some degree are miscible with water. In another embodiment, the drag reducing composition can be prepared by combining a fast-dissolving dispersion polymer and a non-aqueous slow-dissolving polymer slurry by utilizing surfactants, co-surfactants, solvents, co-solvents and mutual solvents. The choice of specific drag reducing additives necessary to make usable composition would be known to a person skilled in the art.

In some embodiments the fast-dissolving polymer is a solid polymer comprising particles of less than 1000 micrometer in diameter. In some embodiments, the fast-dissolving polymer comprises more than one polymer. In some embodiments, the fast-dissolving polymer comprises oppositely charged polymers. In some embodiments, the fast-dissolving polymer comprises a mixture of charged and uncharged polymer. In some embodiments, the fast-dissolving polymer comprises similarly charged polymers. In some embodiments, the fast-dissolving polymer comprises a zwitterionic polymer. In some embodiments, the fast-dissolving polymer comprises an amphoteric polymer. In some embodiments, the fast-dissolving polymer is a random homopolymer or co-polymer. In some embodiments, the fast-dissolving polymer is a block homopolymer or co-polymer. In some embodiments, the fast-dissolving polymer is a co-polymer or homopolymer with a branched structure. In some embodiments, a polymer with a branched structure is a dendrimer. In some embodiments, a polymer with a branched structure is a star polymer. In some embodiments, the fast-dissolving polymer is a partially crosslinked polymer. In some embodiments, the fast-dissolving polymer is a molecularly associated polymer. In some embodiments, the fast-dissolving polymer is a partially hydrolyzed polymer. In some embodiments, the fast-dissolving polymer is a partially hydrolyzed polyacrylamide. In some embodiments, the fast-dissolving polymer is a thermoplastic polymer.

In certain embodiments, a slow-dissolving polymer slurry is a polymer slurry that when dosed at two pounds per thousand gallons of carrier fluid (e.g., aqueous solution), reaches maximum drag reduction at a time greater than two minutes in a flow loop test (e.g., see working examples), which can be used for the purpose of screening and selecting suitable drag reducing compositions.

In certain embodiments, the composition comprises from about 70 wt % to about 98 wt %, or from about 75 wt % to about 95 wt %, or from about 80 wt % to about 90 wt %, or from about 82 wt % to about 88 wt %, or from about 84 wt % to about 86 wt % of the slow-dissolving polymer slurry, versus the total weight of the composition.

In certain embodiments, the slow-dissolving polymer slurry is non-aqueous comprising a dispersion medium that is not water and comprising solid polymer particles, such as guar. In some embodiments, the non-aqueous dispersion medium is oil. In certain embodiments, the oil is a mineral oil. In some embodiments, the dispersion medium comprises a glycol.

In some embodiments, the slow-dissolving polymer slurry comprises a solid polymer comprising particles of less than 1000 micrometer in diameter. In some embodiments, the slow-dissolving polymer slurry comprises more than one polymer. In some embodiments, the slow-dissolving polymer slurry comprises oppositely charged polymers. In some embodiments, the slow-dissolving polymer slurry comprises charged and uncharged polymers. In some embodiments, the slow-dissolving polymer slurry comprises similarly charged polymers. In some embodiments the slow-dissolving polymer slurry comprises uncharged polymers. In some embodiments, the slow-dissolving polymer slurry comprises a zwitterionic polymer. In some embodiments, the slow-dissolving polymer slurry comprises an amphoteric polymer. In some embodiments, the slow-dissolving polymer slurry comprises a random homopolymer or co-polymer, which may be branched or unbranched. In some embodiments, a polymer with a branched structure is a dendrimer. In some embodiments, a polymer with a branched structure is a star polymer.

In some embodiments, the slow-dissolving polymer is a partially crosslinked polymer. In some embodiments, the slow-dissolving polymer is a molecularly associated polymer. In some embodiments, the slow-dissolving polymer is a partially hydrolyzed polymer. In some embodiments, the slow-dissolving polymer comprises a thermoplastic polymer.

In certain embodiments, the composition comprises any suitable amount of the slow-dissolving polymer (e.g., not including the clay and/or oil). According to certain embodiments, the composition comprises greater than about 30 wt %, greater than about 40 wt %, greater than about 50 wt %, greater than about 60 wt %, greater than about 70 wt %, greater than about 80 wt %, greater than about 90 wt %, or greater than about 95 wt % of the slow-dissolving polymer, versus the total weight of the composition. In some embodiments, the composition comprises less than about 95 wt %, less than about 90 wt %, less than about 80 wt %, less than about 70 wt %, less than about 60 wt %, less than about 50 wt %, or less than about 40 wt % of the slow-dissolving polymer, versus the total weight of the composition.

According to some embodiments, the composition comprises a slow-dissolving polymer slurry. Generally, the slow-dissolving polymer slurry comprises a slow-dissolving polymer and at least one additional component. In some embodiments, the at least one additional component comprises an oil or other liquid in which the slow-dissolving polymer is insoluble but is distributed in a form of a slurry or suspension. The slow-dissolving polymer may be present in the slurry in any suitable amount (e.g., at least about 1 lb., or at least about 2 lbs., or at least about 3 lbs., or at least about 4 lbs., or at least about 5 lbs., or at least about 10 lbs., or more, of the slow-dissolving polymer in 1 gallon of fluid (e.g., oil)).

According to certain embodiments, the slow-dissolving polymer may be a natural polymer. In some embodiments, the slow-dissolving polymer is a polysaccharide. In some embodiments, the polysaccharide comprises a guar. In certain embodiments, the slow-dissolving polymer is a guar. As will be known to those in the art, guar (also sometimes referred to as guar gum) is a polysaccharide derived from guar beans, and in some cases, has useful thickening and stabilizing properties. Guar (or guar gum) is generally classified as a galactomannan, which is a polysaccharide comprising a mannose backbone with galactose side groups. Other non-limiting examples of slow-dissolving polymers include derivatized guar gum, xanthan gum, cellulose-based polymers, fructans, and starches, both modified and unmodified. Some non-limiting examples of derivatized guar gum include carboxymethyl hydroxypropyl guar, hydroxypropyl guar, carboxymethyl guar. Some non-limiting examples of cellulose-based polymers include carboxymethyl cellulose, hydroxyethyl cellulose, hydroxypropyl cellulose, hydroxypropyl methyl cellulose, hydroxybutyl methyl cellulose and mixtures thereof. In some embodiments, a slow-dissolving polymer slurry comprises a mixture of more than one slow-dissolving polymers. In some embodiments, a slow-dissolving polymer is a retarded fast-dissolving polymer. A retarded fast-dissolving polymer is a polymer whose normally anticipated rate of dissolution has been substantially decreased via chemical or physical modification of the polymer. In certain embodiments, the slow-dissolving polymer slurry comprises guar and clay in an oil-based slurry.

The oil in the slow-dissolving polymer slurry may be any base oil. In some embodiments, the oil may be mineral oil, synthetic oil, crude oil, diesel oil or any oil derived from a natural source (e.g. vegetable oil). In some embodiments, the oil is an oil in which the fast-dissolving polymer is not soluble. That is, the fast-dissolving polymer is in the form of a slurry in the oil. In certain embodiments, the oil is an oil in which the slow-dissolving polymer is not soluble. In certain embodiments, the slow-dissolving polymer is in the form of a slurry in an oil.

In some embodiments, the slow-dissolving polymer slurry comprises at least one additive. In some embodiments, an additive is an oilfield chemical. Non-limiting examples of additives include clay, a surfactant, and/or a viscosity modifier. In certain embodiments, the clay may be smectite clay. In certain embodiments, the clay may be bentonite, laponite, or the like. In some embodiments, an oilfield chemical is a chemical other than a drag reducer or a viscosifier. In some embodiments, an additive may be a scale inhibitor, clay control agent, iron control agent, salt control agent, corrosion inhibitor, complexing agent, a breaker, a cross-linker. In some embodiments, an additive comprises a surfactant, a solvent, or a microemulsion.

In certain embodiments, when a composition comprising the slow-dissolving polymer is added to the carrier fluid of a wellbore, the slow-dissolving polymer aids in reducing drag between the carrier fluid and the inner side walls of the pipes or tubes connected to the wellhead and the inner side walls of the casing found downhole in the wellbore. According to some embodiments, the slow-dissolving polymer provides a reduction in drag at a time scale of less than about 3.0 minutes, less than about 5.0 minute, less than about 10.0 minutes, less than about 15.0 minutes, or less than about 20.0 minutes. In certain embodiments, the slow-dissolving polymer provides a reduction in drag at a time scale of greater than about 2.0 minutes, greater than about 3.0 minutes, greater than about 5.0 minutes, greater than about 10.0 minutes, greater than about 15.0 minutes, or greater than about 19.0 minutes. Combinations of these ranges are also possible (e.g., greater than 2.0 minutes and less than 10.0 minutes, greater than 5.0 minutes and less than 15.0 minutes).

In some embodiments, the composition consists of or consists essentially of the fast-dissolving polymer and the slow-dissolving polymer slurry. In some embodiments, the composition consists or consists essentially of a fast-dissolving polymer that is a nonionic, zwitterionic, amphoteric, cationic, or anionic polymer of acrylamide or co-polymer of acrylamide with other monomers, and a slow-dissolving polymer slurry. In certain embodiments, slow-dissolving polymer slurry consists or consists essentially of guar, clay, and water-immiscible liquid, such as oil. According to some embodiments, the composition consists or consists essentially of a fast-dissolving polymer that is a nonionic, zwitterionic, amphoteric, cationic, or anionic polymer of acrylamide or co-polymer of acrylamide with other monomers, and a slow-dissolving polymer slurry that comprises guar, clay, and oil. In some embodiments, the composition comprising a fast-dissolving polymer and a slow-dissolving polymer slurry may have high viscosity, exhibit properties of a non-Newtonian fluid, or may be a paste.

In some embodiments the composition may emulsify or microemulsify when mixed with the carrier fluid, wherein an emulsion or a microemulsion would form, as would be understood by a person of ordinary skill in the art.

The compositions described herein may be formed using methods known to those of ordinary skill in the art. In some embodiments, the fast-dissolving polymer and the slow-dissolving polymer slurry may be combined (e.g., polyacrylamide and guar, clay, and oil slurry). The strength, type, and length of the agitation may be varied as known in the art depending on various factors including the components of the composition, the quantity of the composition, and the resulting type of composition formed. For example, for small samples, a few seconds of gentle mixing can yield a well-mixed composition, whereas for larger samples, longer agitation times and/or stronger agitation may be required. Agitation may be provided by any suitable source, e.g., a vortex mixer, a stirrer (e.g., magnetic stirrer), in-line mixer, etc. as would be known to a person of ordinary skill in the art.

It should be understood, that while many of the embodiments described herein relate to a composition comprising a fast-dissolving polymer and a slow-dissolving polymer slurry, this is by no means limiting, and those skilled in the art will be able to apply the teachings described herein to other composition comprising a slurry comprising a fast-dissolving polymer, a slow-dissolving polymer, and an oil, and optionally as least one additives. For example, a composition comprising a slurry may be formed by combining an oil, a fast-dissolving polymer, and a slow-dissolving polymer, and optionally any additives. As another example, a composition comprising a slurry may be formed by combining a slow-dissolving polymer and a fast-dissolving polymer slurry (e.g., comprising a fast-dissolving polymer, an oil, and optionally at least one additive).

Any suitable method for injecting the composition into a wellbore may be employed. For example, in some embodiments, the composition may be injected into a subterranean formation by injecting it into a well or wellbore in the zone of interest of the formation and thereafter pressurizing it into the formation for the selected distance. Methods for achieving the placement of a selected quantity of a mixture in a subterranean formation are known in the art. The well may be treated with the composition for a suitable period of time. The composition and/or other fluids may be removed from the well using known techniques, including producing the well.

It should be understood, that in embodiments where a composition is said to be injected into a wellbore, that the composition may be diluted and/or combined with other liquid component(s) prior to and/or during injection (e.g., via straight tubing, via coiled tubing, etc.). For example, in some embodiments, the composition is diluted with an aqueous carrier fluid (e.g., water, brine, sea water, fresh water, produced water, reverse osmosis water, or a well-treatment fluid, such as an acid, a fracturing fluid comprising polymers, produced water, treated water sand, slickwater, etc.) prior to and/or during injection into the wellbore. In some embodiments, a composition for injecting into a wellbore is provided comprising a composition as described herein and an aqueous carrier fluid.

In some embodiments, the carrier fluid may comprise a brine. Brine is an aqueous solution having total dissolved solids (TDS). As used herein, TDS means the amount of total dissolved solid substances, for example salts, in the carrier fluid. Furthermore, TDS typically defines the ion composition of the carrier fluid. The TDS is measured in parts per million (ppm).

According to some embodiments, the brine may have any of a variety of concentrations. In certain embodiments, the carrier fluid (e.g., water and/or brine) may have any of a variety of suitable total dissolved solids (TDS).

In some embodiments, the TDS of the brine is from 0 ppm to about 50,000 ppm of TDS, from 0 ppm to about 100,000 ppm of TDS, from 0 ppm to about 150,000 ppm of TDS, from 0 ppm to about 200,000 ppm of TDS, from 0 ppm to about 250,000 ppm of TDS, from 0 ppm to about 300,000 ppm of TDS, from 0 ppm to about 350,000 ppm of TDS, or from 0 ppm to about 400,000 ppm of TDS. In describing the TDS of brine, it is common to omit the “of” or the ppm units. Thus, for example, 400,000 ppm of TDS can be described as 400,000 ppm TDS, 400,000 ppm, 400,000 TDS, or 400K TDS.

In some embodiments, the water or brine in the carrier fluid may have greater than or equal to about 50,000 TDS, greater than or equal to about 100,000 TDS, greater than or equal to about 150,000 TDS, greater than or equal to about 200,000 TDS, greater than or equal to about 250,000 TDS, greater than or equal to about 300,000 TDS, greater than or equal to 350,000 TDS, or greater than or equal to about 400,000 TDS.

In other embodiments, the water or brine in the carrier fluid may have less than or equal to about 50,000 TDS, less than or equal to about 100,000 TDS, less than or equal to about 150,000 TDS, less than or equal to about 200,000 TDS, less than or equal to about 250,000 TDS, less than or equal to about 300,000 TDS, less than or equal to about 350,000 TDS, or less than or equal to about 400,000 TDS.

In some embodiments, the total dissolved solids may be from about 50,000 TDS and about 300,000 TDS. Examples of TDS include Al³⁺, Mg²⁺, Ca²⁺, Ba²⁺, Sr²⁺, Na⁺, K⁺, NH₄⁺, Cl⁻, HCO₃⁻, SO₄²⁻, etc. In certain embodiments, the TDS may comprise transition metals (e.g., Cr³⁺, Ti⁴⁺, Zr⁴⁺, Fe²⁺, Fe³⁺). According to some embodiments, the presence of TDS in the carrier fluid, such as Fe³⁺, does not inhibit the function of the composition. In some other embodiments the TDS may also include compounds of boron and phosphorus. In some embodiments, the carrier fluid is a hydraulic fracturing fluid. In some embodiments, the carrier fluid is an acidizing fluid. In some embodiments, the carrier fluid may have a tendency to form scale and may or may not be treated with scale controlling chemical agents.

In some embodiments, the brine comprises a saturated or nearly-saturated solution of salts. In some embodiments, the brine comprises ions. The ions can be negatively charged or positively charged, and can be of different kinds of ions, present in any amount and combination allowing to satisfy the condition of electric neutrality. The ions may comprise alkali metal ions, alkali earth metal ions, ammonium ions, phosphonium ions, hydrozonium ions, pyridinium ions, and/or transition metal ions. In some embodiments, the ions may be organic ions. In some embodiments, the ions may be macromolecular ions. In some embodiments, the ions may comprise Al³⁺ ions. In some embodiments, the ions may comprise alkali metal ions, such as Na⁺, K⁺, or Li⁺ ions. In some embodiments, the alkali earth metal ions may comprise Mg²⁺, Ca²⁺, Sr²⁺, Ba²⁺ ions. In some embodiments, the transition metal ions may comprise Fe, Cr, Zr, Ti, Mn, or V. In some embodiments transition metal ions can be present in the brine in any amount. In some embodiments iron can be present in the brine in the amount up to about 5 to and up to about 500 ppm. In some embodiments iron can be present in the brine in the amount up to about 250 ppm. In some embodiments, the ions may comprise a carbon, a halogen, sulfur, boron, phosphorus, arsenic, or silicon. In some embodiments, ions comprising halogens are Cl⁻, Br⁻ or I⁻ ions. In some embodiments, ions comprising sulfur are SO₄²⁻ ions. In some embodiments, ions comprising boron are borate ions. In some embodiments, ions comprising phosphorus are phosphate ions. In some embodiments, the ions comprise carbonate [CO₃²⁻] ions or hydrocarbonate [HCO₃⁻] ions. In some embodiments, the ions comprise surfactant ions. In some embodiments, the surfactant ions are alkyl or aryl sulfate ions, alkyl or aryl sulfonate ions, or alkyl or aryl carboxylate ions,

Carrier fluids can comprise substances comprising polar, semi-polar, or non-polar molecules. In one embodiment, such molecule is an alcohol. In other embodiments, such molecule is an ether.

The carrier fluids may further comprise suspended solids, which may comprise colloidal particles. The suspended solids may be characterized with particle size distribution, average particle size, weighted particle size, mean particle size, or median particle size. In some embodiments, the suspended solids may comprise subterranean formation particulates, mineral particulates, scale particulates, or deposit particulates. In some embodiments, the suspended solids may comprise sparingly soluble or insoluble oxides, carbonates, sulfates, sulfides, silicates, phosphates, phosphonates or borates. In some embodiments, the phosphates may comprise polyphosphates, pyrophosphates, orthophosphates, metaphosphates, or hexametaphosphates. In some embodiments, the suspended solids may comprise porcilinite. In some embodiments, the suspended solids may comprise hematite and/or magnetite. In some embodiments the suspended solids may comprise suspended clays, wherein the clays may be swelling or non-swelling. In some embodiments, the clays are smectite clays, montmorillonite clays, kaolinite clays, illite clays, or laponite clays.

Carrier fluids can further comprise dissolved or dispersed gases. In some embodiments, gases can comprise hydrogen sulfide, nitrogen, carbon dioxide, ammonia or mixtures thereof. In some embodiments, gases can comprise methane, ethane, propane, cyclopropane, butane, cyclobutane or mixtures thereof. In some embodiments, the gas can comprises a hydrocarbon or a mixture of hydrocarbons.

In some embodiments, the carrier fluid may comprise living or dead organisms, such as bacteria and/or microbes. In some embodiments, the brines may comprise proteins. In some embodiments, the proteins are enzymes.

In some embodiments, the carrier fluids can comprise molecules that are oxidation products. In some embodiments, the carrier fluids may comprise molecules that are products of microbiological activity.

In some embodiments carrier fluids may further comprise polyelectrolytes.

According to some embodiments, the composition is added to the carrier fluid at any of a variety of suitable concentrations. The choice of suitable concentrations is not limited by the delivery capabilities of any given pump or any delivery method. For example, in certain embodiments, the composition is added to the carrier fluid at a concentration of 0.1 gallons of composition per thousand gallons of carrier fluid (e.g., aqueous solution). In some embodiments, the composition is added to the carrier fluid at a concentration of 0.25 gallons of composition per thousand gallons of carrier fluid. In certain embodiments, the composition is added to the carrier fluid at a concentration of 1 gallon of composition per thousand gallons of carrier fluid. In some embodiments, the composition is added to the carrier fluid at a concentration of greater than about 0.1 gallons of composition per thousand gallons of carrier fluid, greater than about 0.25 gallons of composition per thousand gallons of carrier fluid, greater than about 0.50 gallons of composition per thousand gallons of carrier fluid, or greater than 0.75 gallons of composition per thousand gallons of carrier fluid. In certain embodiments, the composition is added to the carrier fluid at a concentration of less than about 1.0 gallon of composition per thousand gallons of carrier fluid, less than about 0.75 gallons of composition per thousand gallons of carrier fluid, less than 0.50 gallons of composition per thousand gallons of carrier fluid, or less than about 0.25 gallons of composition per thousand gallons of carrier fluid. Combinations of these ranges are also possible (e.g., greater than 0.25 gallons and less than 1 gallon of composition per thousand gallons of carrier fluid, greater than 0.50 gallons and less than 0.75 gallons of composition per thousand gallons of carrier fluid). According to some embodiments, when the composition is added to the carrier fluid at a concentration of about 0.25 gallons to about 1.0 gallons of composition per thousand gallons of carrier fluid, the composition functions as a short term drag reducer (via the fast-dissolving polymer) and a long term drag reducer (via the slow-dissolving polymer slurry).

In certain embodiments, the composition is added to the carrier fluid at a concentration greater than 1 gallon of composition per thousand gallons of carrier fluid (e.g., aqueous solution). For example, in certain embodiments, the composition is added to the carrier fluid at a concentration of 6 gallons of composition per thousand gallons of carrier fluid. According to some embodiments, the composition is added to the carrier fluid at a concentration of 10 gallons of composition per thousand gallons of carrier fluid. In some embodiments, the composition is added to the carrier fluid at a concentration of greater than about 1 gallon of composition per thousand gallons of carrier fluid, greater than about 2 gallons of composition per thousand gallons of carrier fluid, greater than about 3 gallons of composition per thousand gallons of carrier fluid, greater than about 4 gallons of composition per thousand gallons of carrier fluid, greater than about 5 gallons of composition per thousand gallons of carrier fluid, greater than about 6 gallons of composition per thousand gallons of carrier fluid, greater than about 7 gallons of composition per thousand gallons of carrier fluid, greater than about 8 gallons of composition per thousand gallons of carrier fluid, or greater than about 9 gallons of composition per thousand gallons of carrier fluid. In certain embodiments, the composition is added to the carrier fluid at a concentration of less than 10 gallons of composition per thousand gallons of carrier fluid, less than 9 gallons of composition per thousand gallons of carrier fluid, less than 8 gallons of composition per thousand gallons of carrier fluid, less than 7 gallons of composition per thousand gallons of carrier fluid, less than 6 gallons of composition per thousand gallons of carrier fluid, less than 5 gallons of composition per thousand gallons of carrier fluid, less than 4 gallons of composition per thousand gallons of carrier fluid, less than 3 gallons of composition per thousand gallons of carrier fluid, or less than 2 gallons of composition per thousand gallons of carrier fluid. Combinations of the above ranges are also possible (e.g., greater than 1 gallon and less than 6 gallons of composition per thousand gallons of carrier fluid, greater than 3 gallons and less than 4 gallons of composition per thousand gallons of carrier fluid). According to certain embodiments, when the composition is added to the carrier fluid at a concentration of about 1.0 gallon to about 10.0 gallons of composition per thousand gallons of carrier fluid, the composition functions as a viscosity increaser.

According to certain embodiments, the compositions described herein do not require hydration equipment during well stimulation. In some embodiments, the fast-dissolving polymer (e.g., polyacrylamide) affords drag reduction while the slow-dissolving polymer slurry (e.g., guar, clay, and oil slurry) provides an increase in viscosity. In certain embodiments, the composition is hydrating in the pump, wellhead, and/or wellbore. According to some embodiments where hydration equipment is unnecessary, the process of well stimulation is easier and more effective than if hydration equipment were required (e.g., time and money can be saved). The composition described herein may be used in various aspects (e.g. steps) of the life cycle of an oil and/or gas well, including, but not limited to, stimulation (including, for example hydraulic fracturing and/or acidizing) and coiled tubing applications.

Various aspects of the well life cycle are described in detail in U.S. patent application Ser. No. 14/212,731, filed Mar. 14, 2014, entitled “METHODS AND COMPOSITIONS FOR USE IN OIL AND/OR GAS WELLS,” now published as US/2014/0284053 on Sep. 25, 2014 and in U.S. patent application Ser. No. 14/212,763, filed Mar. 14, 2014, entitled “METHODS AND COMPOSITIONS FOR USE IN OIL AND/OR GAS WELLS,” now published as US/2014/0338911 on Nov. 20, 2014, each herein incorporated by reference.

As will be understood by those of ordinary skill in the art, the steps of the life cycle of an oil and/or gas well may be carried out in a variety of orders. In addition, in some embodiments, each step may occur more than once in the life cycle of the well. In some embodiments, the compositions described herein are used in methods to treat an oil and/or gas well having a wellbore, wherein the methods may comprise reducing drag in a wellbore and/or increasing the viscosity of the carrier fluid. According to certain embodiments, the composition can be added to a wellbore as a single additive which functions as both a drag reducer and a viscosity increaser.

According to certain embodiments, the carrier fluids may comprise a proppant. In some embodiments, the proppant is resistive to diagenesis. Any of a variety of suitable proppants may be employed, including silica sand and/or ceramics. In some embodiments, the proppant may be a resin coated proppant. In certain embodiments the proppant may have any of a variety of suitable sizes and/or shapes. In certain embodiments the proppant density may be modified by techniques known in the art, such as adhering gas bubbles.

In certain embodiments, methods of using the composition may include pumping fluids over long distances under turbulent conditions. According to certain embodiments, the method of using the composition may include delivering (e.g., injecting) via coiled tubing (e.g., in a wellbore).

Definitions of specific functional groups and chemical terms are described in more detail below. For purposes of this invention, the chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito: 1999, the entire contents of which are incorporated herein by reference.

### EXAMPLES

These and other aspects of the present invention will be further appreciated upon consideration of the following Examples, which are intended to illustrate certain particular embodiments of the invention but are not intended to limit its scope, as defined by the claims.

### Example 1

The following example describes the preparation of a non-limiting example of a composition comprising an anionic fast-dissolving polymer.

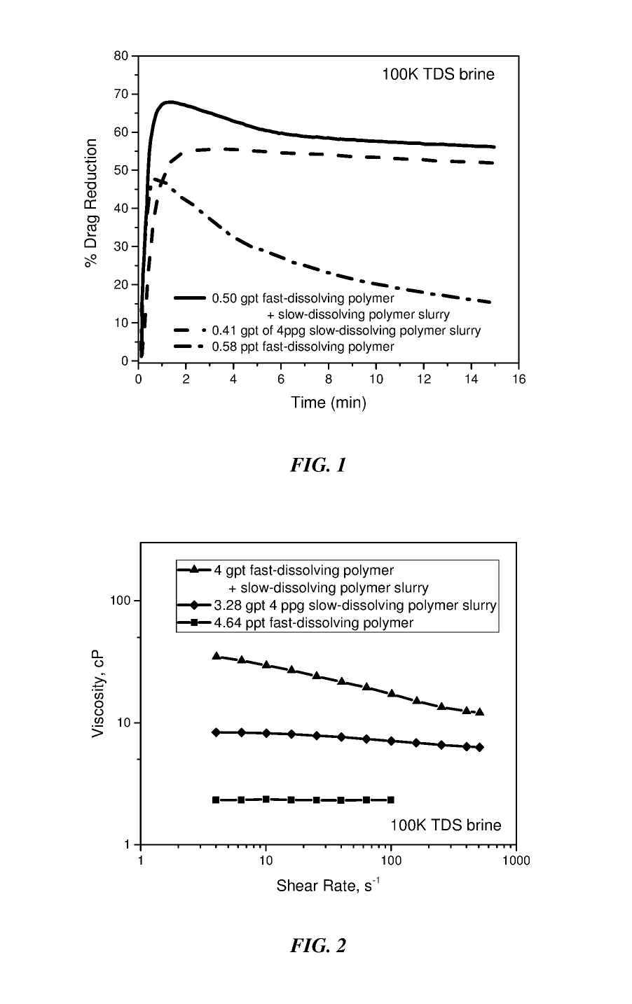

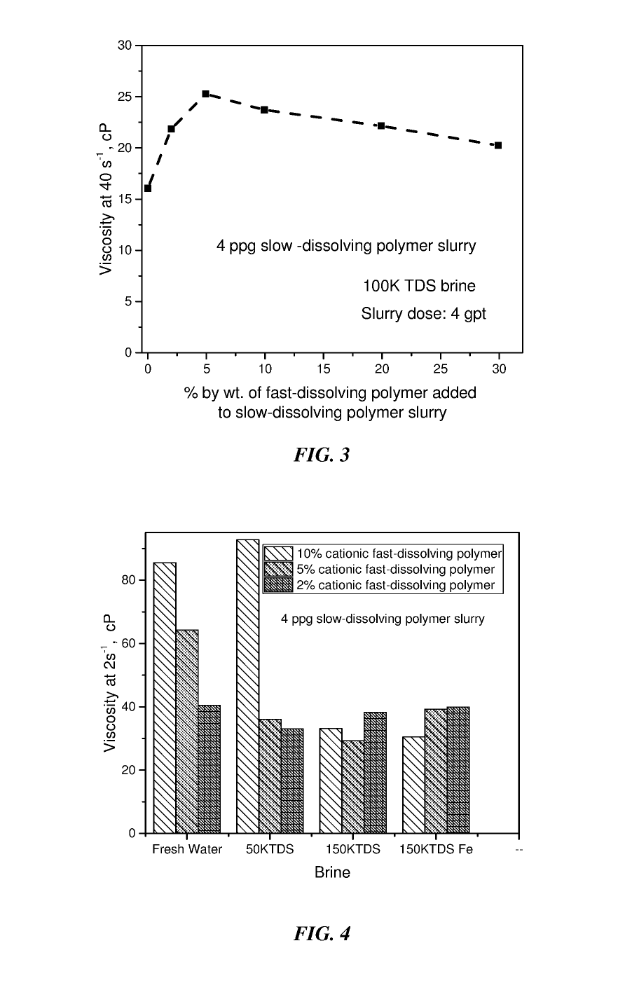

In a 125 mL beaker, 42.5 grams of a slurry containing 4.0 lbs of guar (slow-dissolving polymer) in 1 gallon of mineral oil was mixed with 7.5 grams of an anionic, dry polyacrylamide powder (fast-dissolving polymer). The mixture was hand stirred using a spatula until the dry polyacrylamide powder was evenly dispersed in the slurry. The prepared guar slurry was used to conduct drag reduction evaluation and viscosity measurements as described in Example 3 (see FIG. 1) and 4 (see FIG. 2 and FIG. 3), respectively.

### Example 2

The following example describes the preparation of a non-limiting example of a composition.

A series of compositions containing 4.0 lbs. of guar and varying amounts of anionic, dry powder polyacrylamide were prepared. To prepare the composition, first the appropriate amount of guar slurry (in mineral oil), containing 4.0 lbs. of guar per 1 gallon of mineral oil, was placed into a beaker. An anionic, dry powder polyacrylamide was then carefully added to this guar slurry and stirred by hand with a spatula until the anionic, dry powder polyacrylamide was evenly dispersed in the slurry. The amount of anionic, dry powder polyacrylamide was chosen in such a way that the weight ratios of added polyacrylamide to the guar slurry were 0.05, 0.1, 0.2, and 0.3. The exact amount of guar slurry depends on the batch size desired as known to a person of ordinary skill in the art. The prepared slurries were then used to prepare test fluids for viscosity testing as described in Example 4 (see FIG. 2 and FIG. 3). The concentration of test slurries was 4 gallons per 1000 gallons of 100,000 TDS brine containing 11,300 ppm Ca²⁺, 2,800 ppm Ba²⁺, 25,875 ppm Na³⁰ and 61,333 ppm Cl⁻.

### Example 3

The following example describes a non-limiting method to determine the effect of the composition on drag of a fluid flowing against the walls of the tubing of a flow loop device.

Flow loop devices to evaluate drag reduction are known in the art. The device used for this example consists of a 15 gallon tank from which fluid was pumped at a flow rate of 10 gallons per minute (GPM) by a progressive cavity pump through a series of pipes. The first pipe was 10 feet long with a 0.75 inch outer diameter (OD) and a 0.62 inch inner diameter (ID). The first pipe was connected to a 25 foot long, 0.50 inch OD, 0.42 inch ID stainless steel test pipe. Differential pressure was measured by means of pressure transducers across a 10 foot section of the test pipe called the “Test Section.” The Test Section begins at a point 10 feet along the test pipe. After the fluid flows through the Test Section, it was looped back into the 15 gallon tank. The output of the differential pressure measurements was registered by a computer running LabVIEW® automation software available from the National Instruments® Corporation. It should be understood that other methods of testing drag reduction may be used.

A 15 gallon reservoir was filled with 5 gallons of base fluid comprising either tap water or brine, which provided a baseline and verification of proper operation of the flow loop. The base fluid can also be water produced from a well or other process water. A non-limiting example of a suitable brine is a brine containing approximately 100,000 ppm of TDS (11,300 ppm Ca²⁺, 2,800 ppm Ba²⁺, 25,875 ppm Na⁺ and 61,333 ppm Cl⁻) and is prepared by dissolving the corresponding salts in deionized water as would be known to a person of ordinary skill in the art. The base fluid was circulated for 2 minutes at a flow rate of 10 GPM and the baseline differential pressure was recorded. While the fluid was still being circulated at 10 GPM, the composition of Example 1 was added to the base fluid in the 15 gallon tank at the required dose. The treated base fluid was circulated for an additional 15 minutes, which is referred to as the “test time”. During the test time, the differential pressure was measured continuously. Performing the drag reduction experiment in such a way simulates situations typically encountered in the oilfield, such as in performing hydraulic fracturing jobs. The percent drag reduction (% DR) can be calculated as a function of time as follows:

$$\% DR = \frac{{DP}_{BL} - {DP}_{S}}{{DP}_{BL}} \times 100 \%$$

Where DP_{BL} and DP_{S} are the differential pressures obtained without and with the test additive (e.g., differential pressures of baseline (BL) and sample (S), respectively). The value of DP_{BL} represents 100% drag baseline for tap water or brine.

DP_{BL} can be calculated by a number of known means such as, for example, by using the following set of equations:

$$Δ {P}_{BL} = \frac{L \times v \times ρ \times f}{25.8 \times D}$$

$$v = \frac{Q}{2.45 \times {D}^{2}}$$

$$f = \frac{0.3164}{4} \times {Re}^{0.25}$$

$$Re = \frac{928 \times D \times v \times ρ}{μ}$$

Where L is the length of the test section measured in inches, v is fluid velocity in ft/sec, ρ is the fluid density in lb/gal, D is the internal diameter of the pipe measured in inches, Q is volumetric flow in gals/min, f is the Fanning friction factor, Re is Reynold's number, and μ is the dynamic viscosity of the liquid in cP. The units for differential pressures are psi.

TABLE 1

| | 1 min | 2 min | 4 min | 8 min | 10 min | 14 min |
|---|---|---|---|---|---|---|
| 0.50 gpt fast- | 67.7% | 66.9% | 62.9% | 58.8% | 57.6% | 56.2% |
| dissolving | drag | drag | drag | drag | drag | drag |
| polymer + | reduction | reduction | reduction | reduction | reduction | reduction |
| slow dissolving | | | | | | |
| polymer slurry | | | | | | |
| 0.41 gpt of | 48.7% | 55.2% | 55.4% | 54.2% | 53.3% | 51.8% |
| 4 ppg slow- | drag | drag | drag | drag | drag | drag |
| dissolving | reduction | reduction | reduction | reduction | reduction | reduction |
| polymer slurry | | | | | | |
| 0.58 ppt fast- | 46.1% | 41.9% | 32.3% | 23.1% | 20.2% | 16.0% |
| dissolving | drag | drag | drag | drag | drag | drag |
| polymer | reduction | reduction | reduction | reduction | reduction | reduction |

FIG. 1 (corresponding data shown above in Table 1) shows one embodiment illustrating the drag reduction performance in 100,000 ppm TDS brine achieved using the composition of Example 1. For comparison, FIG. 1 also shows drag reduction obtained by a separate dosing of the slow-dissolving polymer slurry and fast-dissolving polymer. The composition was dosed at 0.5 gallons per 1000 gallons (gpt) of carrier fluid, and the ingredients were tested at doses corresponding to the amounts at which they were present in the dosed composition. All of these doses are comparable to commercially viable and commonly used doses of these additives. According to FIG. 1, the slow-dissolving-polymer slurry (e.g., guar, clay, and oil slurry) individually reaches a maximum drag reduction of about 55.6% at 3.41 minutes. The fast-dissolving polymer (anionic, dry polyacrylamide powder) individually reaches a maximum drag reduction of about 47.9% at 0.82 minutes. The composition reaches a maximum drag reduction of about 67.8% at 1.29 minutes. FIG. 1 indicates that by adding the drag reducing composition of Example 1 to 100K TDS brine, one can pump fluid more effectively as compare to the case when either slow-dissolving or fast dissolving polymer is used by itself. The absolute value of maximum drag reduction is higher and is reached within 2 minutes since the addition of drag reducing composition to the 100K TDS brine. At all corresponding times, the percent drag reduction achieved with the composition was higher than drag reduction achieved with the individual components. The composition provides greater than 65% drag reduction at times of less than 2 minutes and a sustained level of drag reduction exceeding 56% over the remaining test time. Furthermore, the shape of the drag reduction curve in FIG. 1 is “hybrid” between the shapes of the curves obtained for each constituent components, which is indicative of a good resistance of fluid with added drag reducing composition of Example 1 to the degradation by shear. That is, the curve shape at a short time range resembles that of the curve for fast-dissolving polymer, but with a much higher value of drag reduction maximum, while at longer times the composition retains the behavior characteristic of the slow-dissolving polymer slurry (e.g. guar slurry) with yet consistently higher value of % drag reduction.

### Example 4

The following example describes a non-limiting method to determine the effect of the composition on fluid viscosity.

The test fluid was prepared by adding 250 mL of base fluid (100,000 ppm TDS brine), such as tap water or brine, to the jar of a Waring blender, which was plugged into a variable voltage transformer. The blender was turned on to the lowest setting and the variable voltage transformer was adjusted so that the blender blades rotate at about 1,800 rpm creating a vortex in the base fluid. The composition of Example 1, as well as its constituent components, was added to the vortex in the base fluid. The treated fluid was allowed to mix for 30 seconds and then the blender was turned off. Immediately, 23 mL of the treated fluid was transferred to the test cup of a TA Instruments DHR-3 rheometer equipped with a concentric cylinder test geometry set to 20° C. The upper bob was lowered into the test cup and rotated at 511 s⁻¹ for 30 minutes. Then, the fluid viscosity in centipoise (cP) as a function of shear rate was measured from 4 s⁻¹ to 511 s⁻¹ with 5 points per decade on a logarithmic scale. In one embodiment, the composition of Example 1 was dosed at 4 gallons per 1000 gallons of carrier fluid, and the constituent components were tested at doses corresponding to the amounts at which they were present in the dosed composition. The results of this testing are shown in FIG. 2 (corresponding data shown below in Table 2), which shows the carrier fluid viscosity as a function of shear rate for the composition and its constituent components in 100,000 TDS brine. At all corresponding shear rates, the composition had a higher viscosity than the viscosity of the individual constituent components of the composition. Meaning that the drag reducing composition of Example 1 is more suitable for effective proppant transport as compared to either slow-dissolving or fast-dissolving polymer by itself. The viscosity of the composition was higher than the viscosities of slow-dissolving polymer slurries and fast-dissolving polymer by a factor from about 2 to about 15. Also, the carrier fluid comprising the composition demonstrated the highest extent of shear thinning, as qualitatively seen by a faster decrease in viscosity with increase in shear rate. Shear thinning is known to a person of ordinary skill in the art as an example of a non-Newtonian behavior. Higher shear thinning behavior of compositions is beneficial for their use in stimulation applications because on the one hand, such compositions are easier to be delivered by pumping at high shear rate and on the other hand, such compositions when added to the fluid can increase the viscosity such that the fluid is capable to transport proppant while keeping it suspended when the shear rate decreases as the composition travels downhole. A person of ordinary skill in the art would know a number of models and methods that can be used to quantitatively characterize shear thinning. One non-limiting example to characterize shear thinning is to calculate and compare the slopes of the linear portions of the log-log plots shown in FIG. 2. Such calculation yields approximately −0.24 for the composition of Example 1 comprising fast-dissolving polymer and slow-dissolving polymer slurry; −0.07 for slow-dissolving polymer slurry, and −0.001 for the fast-dissolving polymer.

TABLE 2

| | 5 s⁻¹ | 10 s⁻¹ | 100 s⁻¹ | 504 s⁻¹ |
|---|---|---|---|---|
| 4 gpt fast-dissolving polymer + | 33.6 cP | 30.0 cP | 17.3 cP | 11.96 cP |
| slow-dissolving polymer slurry | | | | |
| 3.28 gpt of 4ppg slow-dissolving | 8.24 cP | 8.17 cP | 7.01 cP | 6.24 cP |
| polymer slurry | | | | |
| 4.64 ppt fast-dissolving polymer | 2.29 cP | 2.31 cP | 2.30 cP | — |

FIG. 3 (corresponding data shown below in Table 3) shows, according to some embodiments, the carrier fluid viscosity at 40 s⁻¹ for a series of compositions prepared as described in Example 2. FIG. 3 shows that the addition of small amounts of fast-dissolving polymer to the slurry of 4.0 lbs. slow-dissolving polymer per gallon of oil, results in a 50% increase in viscosity. By increasing the wt % of fast-dissolving polymer, the viscosity of the composition decreases. FIG. 3 shows that the maximum viscosity of the Example 2 composition revealed a maximum viscosity in a particular and rather narrow range, between about 5% and about 10% of fast-dissolving polymer. While that range would be most preferable for achieving highest viscosity for effective proppant transport, the most preferable composition for pumping downhole must also exhibit effective drag reduction performance. FIG. 1 and FIG. 3 indicate that the selection of the most preferable composition needs to be based on the combination of drag reduction and viscosity data.

TABLE 3

| | | | | | | |
|---|---|---|---|---|---|---|
| weight % of fast- | 0 | 2 | 5 | 10 | 20 | 30 |
| dissolving polymer | | | | | | |
| added to 4 ppg | | | | | | |
| slow-dissolving | | | | | | |
| polymer slurry | | | | | | |
| viscosity (cP) | 16.05 | 21.86 | 25.27 | 23.71 | 22.15 | 20.24 |
| at 40 s⁻¹, 4 gpt | | | | | | |
| in 100K | | | | | | |
| TDS brine | | | | | | |

### Example 5

The following example describes the preparation of a non-limiting example of compositions comprising a cationic fast-dissolving polymer.

A series of compositions containing 4.0 lbs. of guar and varying amounts of cationic, dry polyacrylamide powder were prepared. To prepare the compositions, first the appropriate amount of guar slurry in mineral oil, containing 4.0 lbs. of guar per 1 gallon of mineral oil, was placed into a beaker. A cationic, dry polyacrylamide powder was then carefully added to this guar slurry and stirred by hand with a spatula until the anionic, dry polyacrylamide powder was evenly dispersed in the slurry. The amount of cationic, dry polyacrylamide powder was chosen in such a way that the weight ratios of added dry polyacrylamide powder to the guar slurry were 0.02, 0.05, and 0.1. The exact amount of guar slurry depends on the batch size desired as known to a person of ordinary skill in the art. The prepared slurries were then used to prepare test fluids for viscosity testing as described in Example 6 and drag reduction testing as described in Example 7.

### Example 6

The following example describes a non-limiting method to determine the effect of compositions comprising a cationic fast-dissolving polymer on fluid viscosity.

The test fluid was prepared by adding 250 mL of base fluid, such as tap water or brine, to the jar of a blender, which was plugged into a variable voltage transformer. Four different brined were used to generate data of this Example. Brines were prepared by dissolving salts in deionized water. Specifically, 1 gallon of the prepared 50,000 TDS brine contained 124.49 g of NaCl, 78.5 g of CaCl₂×2H₂O, 9.42 g of BaCl₂×2H₂O, and 0.32 g of Na₂SO₄; 1 gallon of the prepared 100,000 TDS brine contained 248.98 g of NaCl, 157 g of CaCl₂×2H₂O, 18.84 g of BaCl₂×2H₂O, and 0.32 g of Na₂SO₄; 150,000 TDS brine contained brine contained 373.48 g of NaCl, 235.5 g of CaCl₂×2H₂O, 28.27 g BaCl₂×2H₂O, and 0.32 g of Na₂SO₄. Another 150,000 TDS iron-containing brine was also prepared by adding 100 ppm of Fe (iron) salt to the above described 150,000 TDS brine. The blender was turned on to the lowest setting and the variable voltage transformer was adjusted so that the blender blades rotate at about 1,800 rpm creating a vortex in the base fluid. The composition of Example 5, was added to the vortex in the base fluid at a dose of 4 gallons per 1000 gallons of carrier fluid. The treated fluid was allowed to mix for 1 minute and then the blender was turned off. After mixing for 1 minute, the treated fluid was poured back and forth 10 times. Immediately, 23 mL of the treated fluid was transferred to the test cup of a TA Instruments® DHR-3 rheometer equipped with a concentric cylinder test geometry set to 20° C. The upper bob was lowered into the test cup and rotated 2 s⁻¹ to 511 s⁻¹. Then, the fluid viscosity in centipoise (cP) as a function of shear rate was measured from 2 s⁻¹ to 511 s⁻¹ with 5 points per decade on a logarithmic scale.

TABLE 4

| | 2% cationic fast- | 5% cationic fast- | 10% cationic fast- |
|---|---|---|---|
| | dissolving polymer | dissolving polymer | dissolving polymer |
| Fresh water | 40.43 cP at 2 s⁻¹ | 64.25 cP at 2 s⁻¹ | 85.49 cP at 2 s⁻¹ |
| 50K TDS brine | 33.02 cP at 2 s⁻¹ | 35.97 cP at 2 s⁻¹ | 92.75 cP at 2 s⁻¹ |
| 150K TDS brine | 38.29 cP at 2 s⁻¹ | 29.28 cP at 2 s⁻¹ | 33.10 cP at 2 s⁻¹ |
| 150K TDS brine Fe | 39.91 cP at 2 s⁻¹ | 39.29 cP at 2 s⁻¹ | 30.45 cP at 2 s⁻¹ |

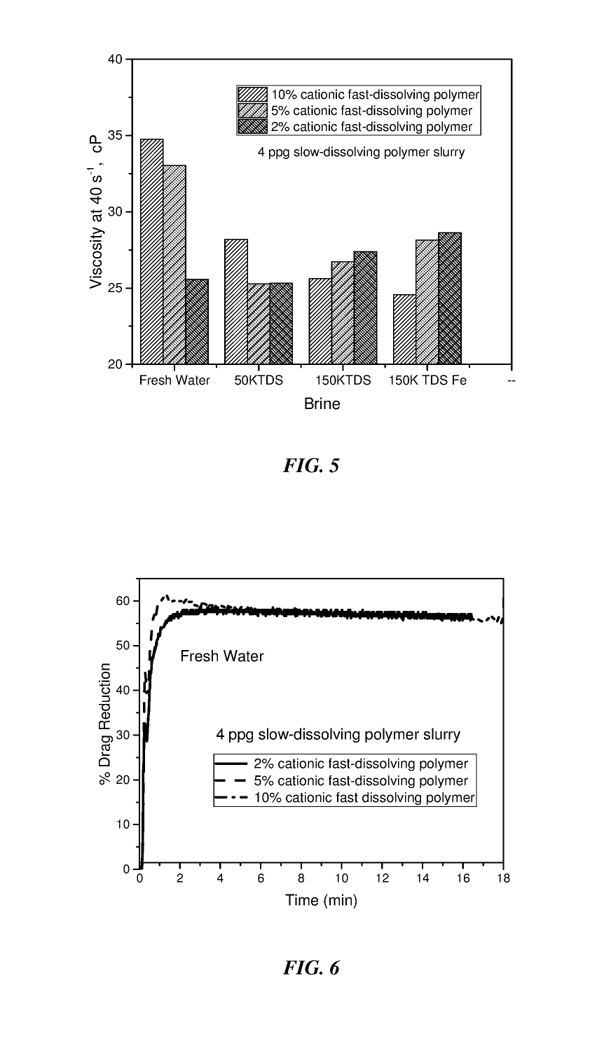

FIG. 4 (corresponding data shown above in Table 4) shows the results of the experiment described in Example 6. Specifically, FIG. 4 shows the viscosity of Example 5 compositions comprising cationic fast-dissolving polymer measured at a low shear rate of 2 s⁻¹ in different brines. Such low shear rate is indicative of the ability of a fluid to resist settling of a suspended proppant. The higher the low-shear viscosity, the higher the resistance to proppant settling is. FIG. 4 clearly demonstrates that the choice of composition of Example 5 comprising cationic fast-dissolving polymer, strongly depends on the brine composition. For fresh water and lower-TDS brines, such as 50,000 TDS brine, the composition comprising greater than about 10% of fast-dissolving polymer would be preferred, while for heavier brines having higher than 50,000 TDS, and especially for brines containing iron, compositions having less than about 10 wt % of the fast-dissolving polymer would be preferred. FIG. 5 (corresponding data shown below in Table 5) shows that similar trends are also observed at higher shear rate of 40 s⁻¹. However, overall absolute values of viscosity determined at shear rate of 40 s⁻¹ are lower as compared to those at shear rate of 2 s⁻¹, which is consistent with the shear-thinning behavior illustrated in FIG. 2 and explained above in Example 4.

TABLE 5

| | 2% cationic fast- | 5% cationic fast- | 10% cationic fast- |
|---|---|---|---|
| | dissolving polymer | dissolving polymer | dissolving polymer |
| Fresh water | 25.58 cP at 40 s⁻¹ | 33.05 cP at 40 s⁻¹ | 34.77 cP at 40 s⁻¹ |
| 50K TDS brine | 25.33 cP at 40 s⁻¹ | 25.27 cP at 40 s⁻¹ | 28.20 cP at 40 s⁻¹ |
| 150K TDS brine | 27.40 cP at 40 s⁻¹ | 26.72 cP at 40 s⁻¹ | 25.61 cP at 40 s⁻¹ |
| 150K TDS brine Fe | 28.62 cP at 40 s⁻¹ | 28.15 cP at 40 s⁻¹ | 24.56 cP at 40 s⁻¹ |

### Example 7

The following example describes a non-limiting method to determine the effect of compositions comprising a cationic fast-dissolving polymer of Example 5 on drag of a fluid flowing against the walls of the tubing of a flow loop device.

The flow loop device used in this Example 7 was similar, but not identical to the flow loop device used in Example 3. The device used for this example consists of a 15 gallon tank from which fluid was pumped at a flow rate of 10 GPM by a progressive cavity pump through a series of pipes. The first pipe was 25 feet long with a 0.75 inch outer diameter (OD) and a 0.62 inch inner diameter (ID). The first pipe was connected to a 25 foot long, 0.50 inch OD, 0.42 inch ID stainless steel test pipe. Differential pressure was measured by means of pressure transducers across a 10 foot section of the test pipe called the “Test Section.” The Test Section begins at a point 10 feet along the test pipe. After the fluid flows through the Test Section, it was looped back into the 15 gallon tank. The output of the differential pressure measurements was registered by a computer running LabVIEW® automation software available from the National Instruments® Corporation. It should be understood that other methods of testing drag reduction may be used.

For each run, a 15 gallon reservoir was filled with a total of 5 gallons of base fluid with 4 gallons being present in the tank and 1 gallon in the pipes. Base fluid consisted of either fresh (tap) water or brine, which provided a baseline and verification of proper operation of the flow loop. In other embodiments the base fluid can also be water produced from a well or other process water. Brine utilized in this Example was a 150,000 TDS (150K TDS Fe) brine with 100 ppm of iron (Fe). Brine was prepared by dissolving salts in deionized water. Specifically, 1 gallon of the prepared brine contained 373.48 g of NaCl, 235.5 g of CaCl₂×2H₂O, 28.27 g BaCl₂×2H₂O, 0.32 g of Na₂SO₄, and 1.81 g of FeCl₃×6H₂O. The base fluid was circulated for 2 minutes at a flow rate of 10 gallons per minute (GPM) and the baseline differential pressure was recorded. While the fluid was still being circulated at 10 GPM, the composition of Example 5 was added to the base fluid in the 15 gallon tank at the dose of 0.5 gallons per 1000 gallons (gpt). The treated base fluid was circulated for additional 15 minutes of “test time”. A calculation of percent drag reduction was performed as described in Example 3.

TABLE 6

| | 1 min | 2 min | 4 min | 8 min | 10 min | 14 min |
|---|---|---|---|---|---|---|
| 2% cationic fast- | 52.7% | 56.6% | 57.5% | 57.1% | 57.0% | 56.6% |
| dissolving | drag | drag | drag | drag | drag | drag |
| polymer in 4 ppg | reduction | reduction | reduction | reduction | reduction | reduction |
| slow-dissolving | | | | | | |
| polymer slurry | | | | | | |
| 5% cationic fast- | 59.4% | 59.5% | 58.9% | 57.9% | 57.0% | 56.9% |
| dissolving | drag | drag | drag | drag | drag | drag |
| polymer in 4 ppg | reduction | reduction | reduction | reduction | reduction | reduction |
| slow-dissolving | | | | | | |
| polymer slurry | | | | | | |
| 10% cationic | 52.7% | 56.6% | 57.5% | 57.1% | 57.0% | 56.6% |
| fast-dissolving | drag | drag | drag | drag | drag | drag |
| polymer in 4 ppg | reduction | reduction | reduction | reduction | reduction | reduction |
| slow-dissolving | | | | | | |
| polymer slurry | | | | | | |

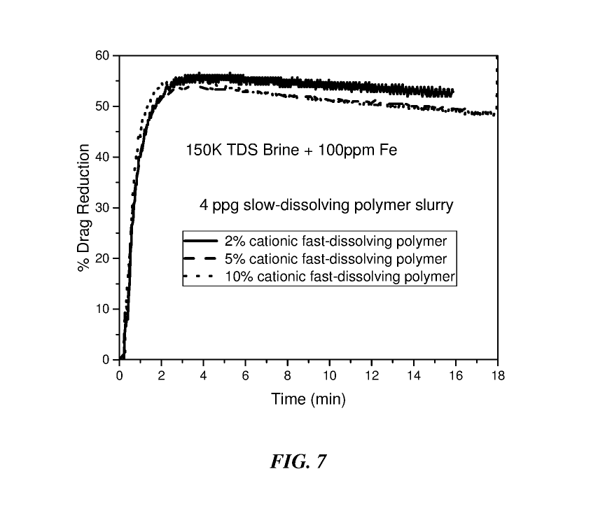

FIG. 6 (corresponding data shown above in Table 6) shows drag reduction effectiveness of Example 5 compositions comprising cationic fast-dissolving polymer measured in fresh water at a dose of 0.5 gpt. This figure shows that in fresh water, a fluid to which a composition comprising 10% of cationic fast-dissolving polymer was added yielded maximum drag reduction of 66.3% achieved at 1.30 minutes, while fluids to which compositions comprising 2% and 5% of cationic fast-dissolving polymer were added, yielded maximum drag reductions of 58.5% and 61.3%, respectively, at 3.05 minutes and 1.37 minutes, respectively. These results indicate that in fresh water composition comprising 10% of cationic fast dissolving polymer yields more effective drag reduction than compositions comprising 2% and 5% of cationic fast-dissolving polymer. FIG. 7 (corresponding data shown below in Table 7) shows drag reduction effectiveness of Example 5 compositions comprising cationic fast dissolving polymer measured in iron-containing 150,000 TDS brine at a dose of 0.5 gpt. This figure shows that oppositely to the case of fresh water (FIG. 6), the highest level of drag reduction was achieved with a fluid comprising the lowest amount of cationic fast dissolving polymer. FIG. 7 shows that at 2% of cationic fast dissolving polymer maximum drag reduction of 56.0% was achieved at 3.27 minutes. The fluids with compositions comprising 5% and 10% of cationic drag reducing polymer yielded maximum drag reduction of 53.8% at 2.88 minutes and 55.5% at 2.67 minutes, respectively. FIG. 7 also shows that fluids prepared with compositions comprising less than 10% of fast-dissolving polymer had better resistance to shear degradation, yielding higher drag reduction values at prolonged circulation as compared to the fluid prepared with a composition comprising 10% of cationic fast-dissolving polymer.

TABLE 7

| | 1 min | 2 min | 4 min | 8 min | 10 min | 14 min |
|---|---|---|---|---|---|---|
| 2% cationic | 40.0% | 52.0% | 55.2% | 53.8% | 53.8% | 53.4% |
| fast-dissolving | drag | drag | drag | drag | drag | drag |
| polymer in 4 ppg | reduction | reduction | reduction | reduction | reduction | reduction |
| slow-dissolving | | | | | | |
| polymer slurry | | | | | | |
| 5% cationic | 40.5% | 51.4% | 53.8% | 52.4% | 51.4% | 50.0% |
| fast-dissolving | drag | drag | drag | drag | drag | drag |
| polymer in 4 ppg | reduction | reduction | reduction | reduction | reduction | reduction |
| slow-dissolving | | | | | | |
| polymer slurry | | | | | | |
| 10% cationic | 43.7% | 54.6% | 54.5% | 52.2% | 51.2% | 49.3% |
| fast-dissolving | drag | drag | drag | drag | drag | drag |
| polymer in 4 ppg | reduction | reduction | reduction | reduction | reduction | reduction |
| slow-dissolving | | | | | | |
| polymer slurry | | | | | | |

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, e.g. elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, e.g. the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element or a list of elements. In general, the term “or” as used herein shall only be interpreted as indicating exclusive alternatives (e.g. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “between” in reference to a range of elements or a range of units should be understood to include the lower and upper range of the elements or the lower and upper range of the units, respectively. For example, the phrase describing a molecule having “between 6 to 12 carbon atoms” should mean a molecule that may have, e.g., from 6 carbon atoms to 12 carbon atoms, inclusively. For example, the phrase describing a composition comprising “between about 5 wt % and about 40 wt % surfactant” should mean the composition may have, e.g., from about 5 wt % to about 40 wt % surfactant, inclusively.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, e.g. to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method of treating a well in a subterranean formation using a treatment fluid comprising the steps of:
providing a drag reducing composition comprising a slow-dissolving polymer slurry and a fast-dissolving polymer, wherein the fast-dissolving polymer is present in an amount of less than or equal to 10 wt % versus the total drag reducing composition;
providing a brine having a total dissolved solids of greater than or equal to 100,000 ppm;
combining the drag reducing composition and the brine together to form the treatment fluid; and
injecting the treatment fluid into the well.

2. The method of claim 1, wherein the fast-dissolving polymer is cationic.

3. The method of claim 1, wherein the fast-dissolving polymer is anionic.

4. The method of claim 1, wherein the brine comprises a transition metal.

5. The method of claim 4, wherein the transition metal comprises iron.

6. The method of claim 5, wherein the iron is present in the brine of up to 250 ppm.

7. The method of claim 1, wherein the slow-dissolving polymer slurry comprises a polysaccharide.

8. The method of claim 7, wherein the polysaccharide comprises a guar.

9. The method of claim 1, wherein the fast-dissolving polymer comprises a synthetic polymer.

10. The method of claim 9, wherein the synthetic polymer comprises polyacrylamide.

11. A method of treating a well in a subterranean formation using a treatment fluid comprising the steps of:
providing a drag reducing composition comprising a slow-dissolving polymer slurry and a fast-dissolving polymer, wherein the fast-dissolving polymer is present in an amount of greater than 10 wt % versus the total drag reducing composition;
providing a brine having a total dissolved solids of less than 100,000 ppm;
combining the drag reducing composition and the brine together to form the treatment fluid; and
injecting the treatment fluid into the well.

12. The method of claim 11, wherein the fast-dissolving polymer is cationic.

13. The method of claim 11, wherein the fast-dissolving polymer is anionic.

14. The method of claim 11, wherein the brine comprises a transition metal.

15. The method of claim 14, wherein the transition metal comprises iron.

16. The method of claim 15, wherein the iron is present in the brine of up to 250 ppm.

17. The method of claim 11, wherein the slow-dissolving polymer comprises a polysaccharide.

18. The method of claim 17, wherein the polysaccharide comprises a guar.

19. The method of claim 11, wherein the fast-dissolving polymer comprises a synthetic polymer.

20. The method of claim 19, wherein the synthetic polymer comprises polyacrylamide.
